(19) United States
(12) Patent Application Publication
(10) Pub. No.: US 2015/0139031 A1
(43) Pub. Date: May 21, 2015

(54) METHOD FOR DISCOVERING NEIGHBOR NODE IN WIRELESS LOCAL AREA NETWORK

(71) Applicant: Electronics and Telecommunications Research Institute, Daejeon (KR)

(72) Inventors: Hyun Duk KANG, Gwangju (KR); Gwang Zeen KO, Daejeon (KR); Igor KIM, Daejeon (KR); Myung Sun SONG, Daejeon (KR); Jin Hyung OH, Daejeon (KR)

(21) Appl. No.: 14/548,826

(22) Filed: Nov. 20, 2014

(30) Foreign Application Priority Data
Nov. 20, 2013 (KR) 10-2013-0141427
Nov. 4, 2014 (KR) 10-2014-0152417

(51) Int. Cl. H04W 48/16; H04W 8/00

(52) U.S. Cl. CPC H04W 48/16; H04W 8/005; H04W 84/12
USPC 370/254

(57) ABSTRACT

Disclosed is a discovery method of neighbor node in a wireless local area network (LAN). The discovery method includes performing a scanning procedure, performing an authentication procedure with a first terminal detected through the scanning procedure, performing an association procedure with the first terminal in which the authentication procedure has been performed, acquiring, from the first terminal, a scanning result of a scanning procedure having been performed in the first terminal, and generating a first AP list based on a scanning result of a scanning procedure having been performed in the first AP and the scanning result of the scanning procedure having been performed in the first terminal Therefore, interference problems between neighbor access points (APs) may be solve.

### CLAIM FOR PRIORITY

This application claims priority to Korean Patent Application No. 10-2013-0141427 filed on Nov. 20, 2013 and No. 10-2014-0152417 filed on Nov. 4, 2014 in the Korean Intellectual Property Office (KIPO), the entire contents of which are hereby incorporated by reference.

### BACKGROUND

1. Technical Field

Example embodiments of the present invention relate in general to wireless local area network (LAN) technology and more specifically to technology that discovers a neighbor access point.

2. Related Art

With the development of information communication technologies, a variety of wireless communication technologies have been developed. Among these technologies, wireless local area network (WLAN) includes technology that is used to make wireless connection to the Internet possible at homes, businesses, or in specific service providing areas using a portable terminal such as a personal digital assistant (PDA), a laptop computer, a portable multimedia player (PMP), or the like, based on wireless frequency technologies.

A standard for WLAN technology has been developed as the standard of the Institute of Electrical and Electronics Engineers (IEEE) 802.11 standard. The WLAN technology according to IEEE 802.11a standard is operated based on an orthogonal frequency division multiplexing (OFDM) method, and may provide a transmission speed of up to 54 Mbps at a 5 GHz band. WLAN technology according to IEEE 802.11b standard is operated based on a direct sequence spread spectrum (DSSS) method and may provide a transmission speed of up to 11 Mbps at a 2.4 GHz band. WLAN technology according to IEEE 802.11g standard is operated based on the OFDM method or the DSSS method, and may provide a transmission speed of up to 54 Mbps at a 2.4 GHz.

WLAN technology according to IEEE 802.11n standard is operated at the 2.4 GHz band and 5 GHz band based on the OFDM method, and may provide, when using a multiple input multiple output-OFDM (MIMO-OFDM) method, a transmission speed of up to 300 Mbps with respect to four spatial streams. The WLAN technology according to IEEE 802.11n standard may support a channel bandwidth of up to 40 MHz, and in this case, provide a transmission speed of up to 600 Mbps.

As such WLAN technology becomes more prevalent and its applications become more diverse, there is increasing a demand for new WLAN technology that can support a higher processing throughput than a data processing speed supported by IEEE 802.11n. Very high throughput (VHT) WLAN technology is one among IEEE 802.11 WLAN technologies proposed to support a data processing speed of 1 Gbps or higher. Among these, IEEE 802.11ac has been developed as a standard for providing VHT in a band at 5 GHz or less, and IEEE 802.11ad has been developed as a standard for providing VHT in a band at 60 GHz.

In recent years, according to an increase in the use of WLAN, a probability to use an overlapped channel between neighbor access points has been increased. In addition, there is a problem in that performance of WLAN is reduced by a hidden access point.

### SUMMARY

Accordingly, example embodiments of the present invention are provided to substantially obviate one or more problems due to limitations and disadvantages of the related art.

Example embodiments of the present invention provide a method for discovering neighbor access points which may solve interference problems between neighbor access points in wireless local area network (WLAN).

In some example embodiments, a discovery method which is performed in a first access point (AP) includes: performing a scanning procedure; performing an authentication procedure with a first terminal detected through the scanning procedure; performing an association procedure with the first terminal in which the authentication procedure has been performed; acquiring, from the first terminal, a scanning result of a scanning procedure having been performed in the first terminal; and generating a first AP list based on a scanning result of a scanning procedure having been performed in the first AP and the scanning result of the scanning procedure having been performed in the first terminal.

Here, the scanning result may include information about at least one AP detected through the scanning procedure.

Also, the first AP list may include at least one AP detected through the scanning procedure having been performed in the first AP and at least one AP detected through the scanning procedure having been performed in the first terminal.

Also, the discovery method may further include: transmitting a first AP discovery indication frame including at least one of the scanning result of the scanning procedure having been performed in the first AP and the first AP list to a terminal satisfying a preset criterion among at least one terminal associated with the first AP; and receiving a first AP discovery confirmation frame that is a response to the first AP discovery indication frame from the terminal satisfying the preset criterion.

Also, the terminal satisfying the preset criterion may be a terminal that detects the largest number of APs through the scanning procedure among the at least one terminal associated with the first AP.

Also, the discovery method may further include: receiving a second AP discovery indication frame from a second terminal; transmitting a second AP discovery confirmation frame to the second terminal as a response to the second AP discovery indication frame; and updating the first AP list based on information included in the second AP discovery indication frame. Here, the second AP discovery indication frame may include at least one of a scanning result of a scanning procedure having been performed in the AP that generates the second AP discovery indication frame and a second AP list generated in the AP that generates the second AP discovery indication frame.

Also, the second AP discovery confirmation frame may include at least one of information for connection setup with the first AP and operating channel information of the first AP.

Also, the discovery method may further include: performing an authentication procedure with a third terminal; performing an association procedure with the third terminal in which the authentication procedure has been performed; acquiring, from the third terminal, a scanning result of a scanning procedure having been performed in the third terminal; and updating the first AP list based on the scanning result of the scanning procedure having been performed in the third terminal.

In other example embodiments, a discovery method which is performed in a first terminal includes: performing a scanning procedure; performing an authentication procedure with a first AP detected through the scanning procedure; performing an association procedure with the first AP in which the authentication procedure has been performed; and transmitting a scanning result of a scanning procedure having been performed in the first terminal to the first AP.

Here, the scanning result may include information about at least one AP detected through the scanning procedure.

Also, the discovery method may further include: receiving, from the first AP, a first AP discovery indication frame including at least one of a first AP list generated based on the scanning result of the scanning procedure having been performed in the first terminal and a scanning result of a scanning procedure having been performed in the first AP, and the scanning result of the scanning procedure having been performed in the first AP; transmitting the first AP discovery indication frame; receiving, from at least one AP that receives the first AP discovery indication frame, a first AP discovery confirmation frame that is a response to the first AP discovery indication frame; and transmitting the first AP discovery confirmation frame to the first AP.

Also, the first AP list may include at least one AP detected through the scanning procedure having been performed in the first AP and at least one AP detected through the scanning procedure having been performed in the first terminal.

Also, the first AP discovery confirmation frame may include at least one of information for connection setup with the AP that transmits the first AP discovery confirmation frame and operating channel information of the AP that transmits the first AP discovery confirmation frame.

Also, a beacon frame instead of the first AP discovery confirmation frame is used to a response of the first AP discovery indication frame.

In still other example embodiments, a first AP includes: a processor; and a memory in which at least one program command executed through the processor is stored. Here, the at least one program command may be executable to perform steps of: performing a scanning procedure; performing an authentication procedure with a first terminal detected through the scanning procedure; performing an association procedure with the first terminal in which the authentication procedure has been performed; acquiring, from the first terminal, a scanning result of a scanning procedure having been performed in the first terminal; and generating a first AP based on a scanning result of a scanning procedure having been performed in the first AP and the scanning result of the scanning procedure having been performed in the first terminal.

Also, the first AP list may include at least one AP detected through the scanning procedure having been performed in the first AP and at least one AP detected through the scanning procedure having been performed in the first terminal.

Also, the at least one program command may be executable to further perform steps of: transmitting a first AP discovery indication frame including at least one of the scanning result of the scanning procedure having been performed in the first AP and the first AP list to a terminal satisfying a preset criterion among at least one terminal associated with the first AP; and receiving a first AP discovery confirmation frame as a response to the first AP discovery indication frame from the terminal satisfying the preset criterion.

Also, the terminal satisfying the preset criterion may be a terminal that detects the largest number of APs through the scanning procedure among the at least one terminal associated with the first AP.

Also, the at least one program command may be executable to further perform steps of: receiving a second AP discovery indication frame from a second terminal; transmitting, to the second terminal, a second AP discovery confirmation frame that is a response to the second AP discovery indication frame; and updating the first AP list based on information included in the second AP discovery indication frame, and the second AP discovery indication frame may include at least one of a scanning result of a scanning procedure having been performed in the AP that generates the second AP discovery indication frame and a second AP list generated in the AP that generates the second AP discovery indication frame.

Also, the second AP discovery confirmation frame may include at least one of information for connection setup with the first AP and operating channel information of the first AP.

Also, the at least one program command may be executable to further perform steps of: performing an authentication procedure with a third terminal; performing an association procedure with the third terminal in which the authentication procedure has been performed; acquiring, from the third terminal, a scanning result of a scanning procedure having been performed in the third terminal; and updating the first AP list based on the scanning result of the scanning procedure having been performed in the third terminal.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating an example of a station that performs methods according to an embodiment of the present invention;

FIG. 2 is a conceptual diagram illustrating an example of a configuration of a wireless local area network (WLAN) system according to the Institute of Electrical and Electronics Engineers (IEEE) 802.11;

FIG. 3 is a flowchart illustrating an association procedure of a terminal in an infrastructure basic service set (BSS);

FIG. 4 is a conceptual diagram illustrating an example of a network in which BSSs are overlapped with each other;

FIG. 5 is a conceptual diagram illustrating another example of a network in which BSSs are overlapped with each other;

FIG. 6 is a conceptual diagram illustrating an example of a centralized topology-based access point (AP) discovery method;

FIG. 7 is a conceptual diagram illustrating a passive method of a distributed topology-based AP discovery method;

FIG. 8 is a conceptual diagram illustrating an active method of a distributed topology-based AP discovery method;

FIG. 9 is a conceptual diagram illustrating a station assistance method of a distributed topology-based AP discovery method;

FIG. 10 is a conceptual diagram illustrating still another example of a network in which BSSs are overlapped with each other; and

FIG. 11 is a flowchart illustrating an AP discovery method according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention will be described in detail with reference to the accompanying drawings. In the drawings and description, elements that appear in more than one drawing and/or elements that are mentioned in more than one place in the description are always denoted by the same respective reference numerals and are not described in detail more than once.

In the entire specification, a station (STA) is an arbitrary functional medium including a medium access control (MAC) layer defined by the Institute of Electrical and Electronics Engineers (IEEE) 802.11 standard, and a physical layer interface with respect to a wireless medium. STAs may be divided into STAs that are access points (APs) and STAs that are non-APs. An STA that is an AP may be simply referred to as an AP, and an STA that is a non-AP may be simply referred to as a terminal.

The STA may include a processor and a transceiver, and may further include a user interface, a display device, and the like. The processor denotes a unit that is designed to generate a frame to be transmitted through a wireless network or process a frame received through the wireless network, and performs a variety of functions for controlling the station (STA). The transceiver may be functionally connected to the processor, and is a unit that is designed to transmit and receive a frame through the wireless network for the STA.

The AP may refer to a centralized controller, a base station (BS), a radio access station, a node-B, an evolved node B, a relay, a mobile multihop relay (MMR)-BS, a base transceiver system (BTS), a site controller, or the like, and may include some or all functions thereof.

The terminal (that is, non-AP) may refer to a wireless transmission/reception unit (WTRU), user equipment (UE), a user terminal (UT), an access terminal (AT), a mobile station (MS), a mobile terminal, a subscriber unit, a subscriber station (SS), a wireless device, a mobile subscriber unit, or the like, and may include some or all functions thereof.

Here, the terminal may refer to a desktop computer, a laptop computer, a tablet PC, a wireless phone, a mobile phone, a smart phone, a smart watch, a smart glass, an e-book reader, a portable multimedia player (PMP), a portable gaming device, a navigation device, a digital camera, a digital multimedia broadcasting (DMB) player, a digital audio recorder, a digital audio player, a digital picture recorder, a digital picture player, a digital video recorder, a digital video player, or the like.

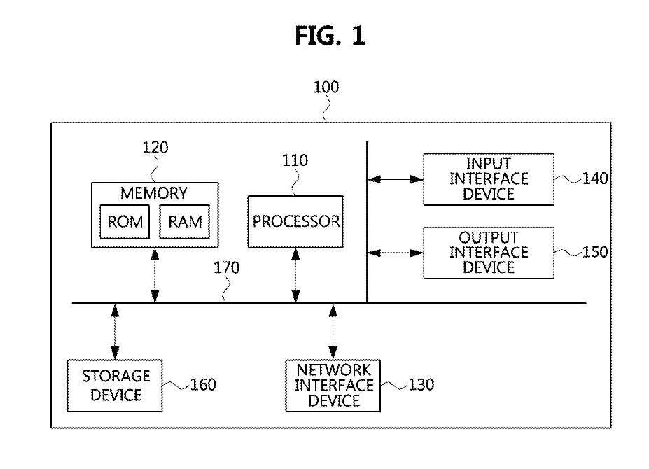

FIG. 1 is a block diagram illustrating an example of a station that performs methods according to an embodiment of the present invention.

Referring to FIG. 1, a station 100 may include at least one processor 110, a memory 120, and a network interface device 130 that is connected to a network to perform communication. In addition, the station 100 may further include an input interface device 140, an output interface device 150, a storage device 160, and the like. The respective components included in the station 100 may be connected by a bus 170 to perform communication with each other.

The processor 110 may execute program commands stored in the memory 120 and/or the storage device 160. The processor 110 may include a central processing unit (CPU), a graphics processing unit (GPU), or a dedicated processor in which methods according to the present invention are performed. The memory 120 and the storage device 160 may be constituted of a volatile storage medium and/or non-volatile storage medium. For example, the memory 120 may be constituted of a read only memory (ROM) and/or a random access memory (RAM).

Embodiments of the present invention may be applied to a wireless local area network (WLAN) system according to IEEE 802.11, and also applied to other communication systems as well as the WLAN system according to IEEE 802.11.

For example, the embodiments of the present invention may be applied to a portable Internet such as a wireless personal area network (WPAN), a wireless body area network (WBAN), a wireless broadband internet (WiBro), or a world interoperability for microwave access (WiMax), a 2G mobile communication network such as a global system for mobile communication (GSM) or a code division multiple access (CDMA), a 3G mobile communication network such as a wideband code division multiple access (WCDMA) or a cdma2000, a 3.5G mobile communication network such as a high speed downlink packet access (HSDPA) or a high speed uplink packet access (HSUPA), a 4G mobile communication network such as a long term evolution (LTE) or LTE-Advanced, a 5G mobile communication network, and the like.

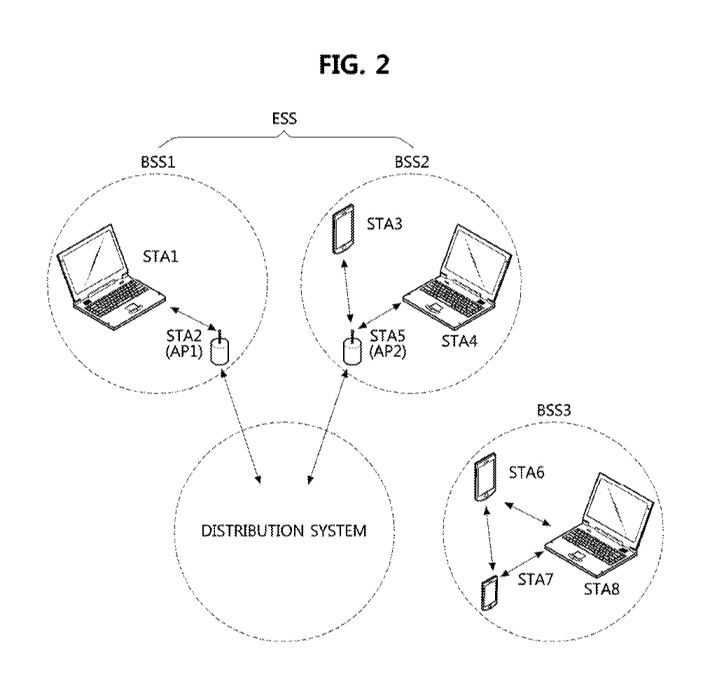

FIG. 2 is a conceptual diagram illustrating an example of a configuration of a WLAN system according to IEEE 802.11.

Referring to FIG. 2, the WLAN system according to IEEE 802.11 may include at least one basic service set (BSS). BSS may include a set of stations STA1, STA2 (AP1), STA3, STA4, STA5 (AP2), STA6, STA7, and STA8 in which synchronization is successfully performed to communicate with each other, and is not a concept which means a specific region.

The BSSs may be divided into infrastructure BSSs and independent BSSs (IBSSs). Here, BSS1 and BSS2 mean the infrastructure BSSs, and BSS3 means the IBSS.

The BSS1 may include a first terminal STA1, a first AP (STA2 (AP1)) that provides distribution services, and a distribution system (DS) that associates a large number of APs (STA2 (AP1), STA5 (AP2)). In the BSS1, the first AP (STA2 (AP1)) may manage the first terminal STA1.

The BSS2 may include a third terminal STA3, a fourth terminal STA4, a second AP (STA5 (AP2)) that provides distribution services, and a DS that associates a large number of APs (STA2 (AP1), STA5 (AP2)). In the BSS2, the second AP (STA5 (AP2)) may manage the third terminal STA3 and the fourth terminal STA4.

The BSS3 means an IBSS that is operated in an ad-hoc mode. In the BSS3, an AP that is a centralized management entity performing a management function at the center does not exist. That is, the terminals STA6, STA7, and STA8 are managed in a distributed manner in the BSS3. In the BSS3, all of the terminals STA6, STA7, and STA8 may mean a mobile terminal, and association with the DS is not allowed, and therefore a self-contained network is formed.

The APs (STA2 (AP1), STA5 (AP2)) may provide association with the DS through a wireless medium for the terminals STA1, STA3, and STA4 coupled to the APs (STA2 (AP1), STA5 (AP2)). In the BSS1 or the BSS2, communication among the terminals STA1, STA3, and STA4 is generally performed through the APs (STA2 (AP1), STA5 (AP2)), but in a case in which a direct link is set, direct communication among the terminals STA1, STA3, and STA4 is possible.

A plurality of infrastructure BSSs may be associated with one another through the DS. The plurality of BSSs associated with each other through the DS are referred to as an extended service set (ESS). Objects STA1, STA2 (AP1), STA3, STA4, STA5 (AP2) included in the ESS may communicate with one another, and arbitrary terminals STA1, STA3, and STA4 within the same ESS may be moved from one BSS to other BSSs while communicating without interruption.

The DS is a mechanism for a single AP to communicate with other APs, and accordingly, the AP may transmit a frame for terminals coupled to the BSS managed by the AP itself, or transmit the frame for an arbitrary terminal moved to the other BSSs. In addition, the AP may transmit and receive the frame with an external network such as a wired network or the like. Such a DS is not necessarily a network, and the DS is not limited to its shape as long as it can provide predetermined distribution services defined in IEEE 802.11. For example, the DS may be a wireless network such as a mesh network, or a physical structure for allowing APs to be associated with one another.

In the infrastructure BSS, the terminal STA may be associated with the AP. The terminal STA may transmit and receive data when being associated with the AP.

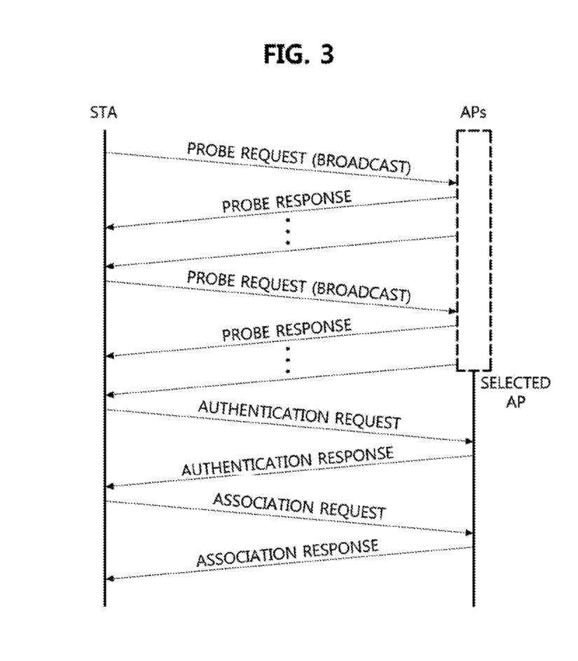

FIG. 3 is a flowchart illustrating an association procedure of a terminal in an infrastructure BSS.

Referring to FIG. 3, an association procedure of the terminal STA in the infrastructure BSS may be roughly divided into a probe step that detects an AP, an authentication step with the detected AP, and an association step with the AP having performed an authentication procedure.

The terminal STA may detect neighbor APs using a passive scanning method or an active scanning method. In a case of using the passive scanning method, the terminal STA may detect the neighbor APs by overhearing beacons transmitted by APs. In a case of using the active scanning method, the terminal STA may detect the neighbor APs by transmitting a probe request frame and receiving a probe response frame that is a response to the probe request frame from the APs.

When detecting the neighbor APs, the terminal STA may perform an authentication step with the detected AP. In this case, the terminal STA may perform the authentication step with a plurality of APs. Authentication algorithms according to IEEE 802.11 may be divided into an open system algorithm that exchanges two authentication frames, a shared key algorithm that exchanges four authentication frames, and the like.

Based on the authentication algorithm according to IEEE 802.11, the terminal STA may complete authentication with the AP by transmitting an authentication request frame and receiving an authentication response frame that is a response to the authentication request frame from the AP.

When completing authentication, the terminal STA may perform an association step with the AP. In this case, the STA may select one AP among the APs having performed the authentication step with the STA itself, and perform an association step with the selected AP. That is, the terminal STA may complete association with the selected AP by transmitting an association request frame to the selected AP and receiving an association response frame that is a response to the association request frame from the selected AP.

Meanwhile, due to an increase in the use of mobile devices such as a smart phone, a tablet PC, and the like, the use of WLAN operated in an unlicensed band is increased. In particular, in a case of Internet traffic, WLAN is responsible for more than half of Internet traffic. Thus, interferences among terminals (that is, included in different BSSs) connected to each of the neighbor APs are increased.

The WLAN system according to IEEE 802.11ac standard may use larger bands of 20 MHz/40 MHz/80 MHz/160 MHz compared to the WLAN system according to IEEE 802.11n standard using bands of 20 MHz/40 MHz. Thus, the respective neighbor APs may use partially or fully overlapped channel with each other. In such an environment, to overcome interference problems among the neighbor APs for efficient use of frequency resources is a critical issue. In particular, interference in a 2.4 GHz band is more serious than interference in a 5 GHz band. In order to minimize the interference in the 2.4 GHz band, setting of a channel bandwidth of 22 MHz or less in the 2.4 GHz band and the use of channels 1, 5, 9, and 13 are recommended.

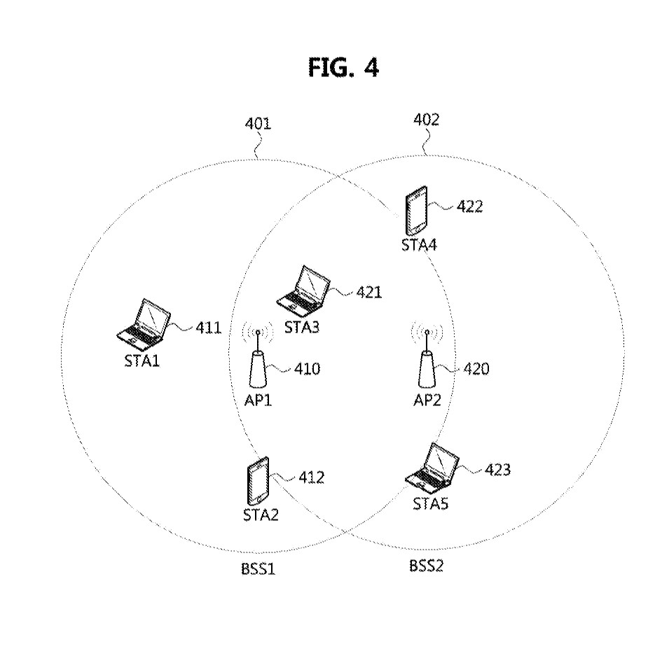

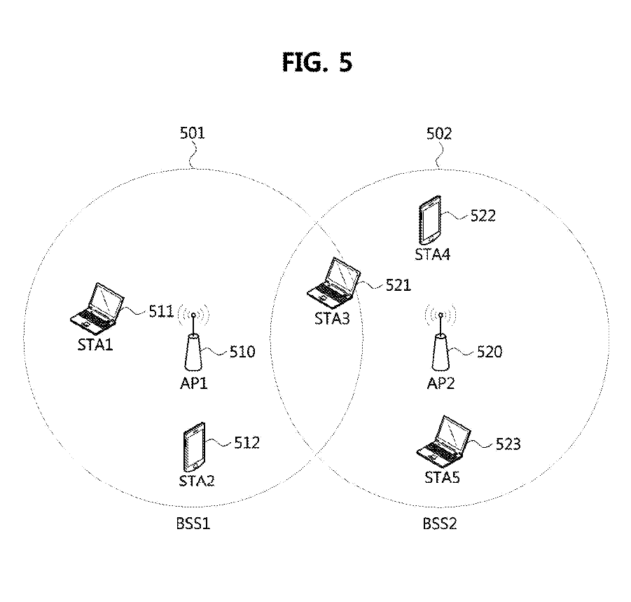

In order to minimize the interferences among the neighbor APs and efficiently use the frequency resources, it is important for a corresponding AP to identify the existence of an AP that can interference with the corresponding AP. With regard to AP discovery, two cases such as a network shown in FIG. 4 and a network shown in FIG. 5 can be considered.

FIG. 4 is a conceptual diagram illustrating an example of a network in which BSSs are overlapped with each other.

Referring to FIG. 4, a first AP 410 may constitute a first BSS 401, and a second AP 420 may constitute a second BSS 402. Within a range of the first BSS 401, the first AP 410, the second AP 420, a first terminal 411, a second terminal 412, and a third terminal 421 may be positioned. Within a range of the second BSS 402, the first AP 410, the second AP 420, the third terminal 421, a fourth terminal 422, and a fifth terminal 423 may be positioned. The first terminal 411 and the second terminal 412 may be associated with the first AP 410. The third terminal 421, the fourth terminal 422, and the fifth terminal 423 may be associated with the second AP 420.

Here, since the first BSS 401 and the second BSS 402 are overlapped with each other, when the first AP 410 and the second AP 420 use the same channel, interference may occur between communication within the first BSS 401 and communication within the second BSS 402. In this case, the first AP 410 can receive a beacon frame transmitted from the second AP 420, and therefore the first AP 410 may identify the existence of the second AP 420. In addition, the second AP 420 can receive a beacon frame transmitted from the first AP 410, and therefore the second AP 420 may identify the existence of the first AP 410. Thus, the first AP 410 and the second AP 420 are not in a hidden-AP relationship, and therefore, in this case, a separate method for AP discovery is not required.

FIG. 5 is a conceptual diagram illustrating another example of a network in which BSSs are overlapped with each other.

Referring to FIG. 5, a first AP 510 may constitute a first BSS 501, and a second AP 520 may constitute a second BSS 502. Within a range of the first BSS 501, the first AP 510, a first terminal 511, a second terminal 512, and a third terminal 521. Within a range of the second BSS 502, the second AP 520, a third terminal 521, a fourth terminal 522, and a fifth terminal 523 may be positioned. The first terminal 511 and the second terminal 12 may be associated with the first AP 510. The third terminal 521, the fourth terminal 522, and the fifth terminal 523 may be associated with the second AP 520.

Here, since the first BSS 510 and the second BSS 502 are overlapped with each other, when the first AP 510 and the second AP 520 use the same channel, interference may occur between communication within the first BSS 501 and communication within the second BSS 502. In this case, the first AP 510 cannot receive a beacon frame transmitted from the second AP 520, and therefore the first AP 510 may not identify the existence of the second AP 520. In addition, the second AP 520 cannot receive a beacon frame transmitted from the first AP 510, and therefore the second AP 520 may not identify the existence of the first AP 510. Thus, the first AP 510 and the second AP 520 are in a hidden-AP relationship, and therefore, in this case, a separate method for AP discovery is necessarily required.

Meanwhile, an AP discovery method may be classified into a centralized topology-based AP discovery method and a distributed topology-based AP discovery method.

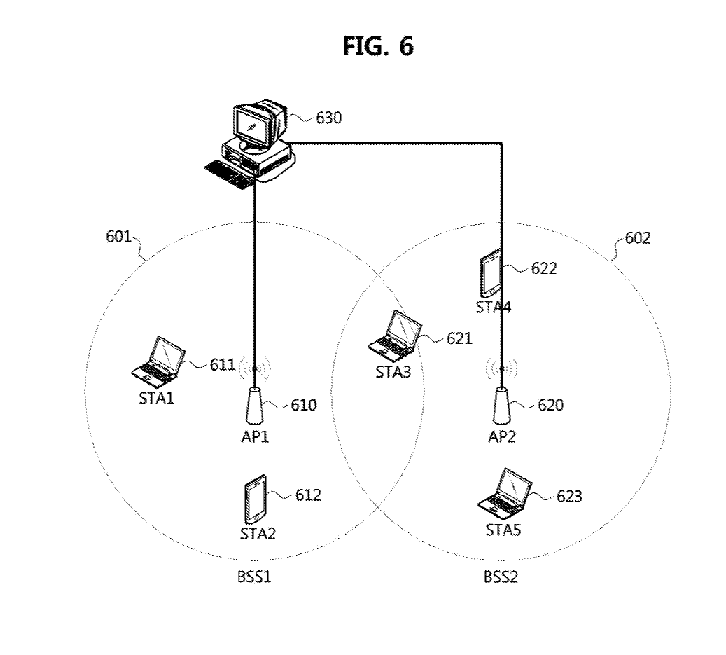

FIG. 6 is a conceptual diagram illustrating an example of a centralized topology-based AP discovery method.

Referring to FIG. 6, a first AP 610 may constitute a first BSS 601, and a second AP 620 may constitute a second BSS 602. Within a range of the first BSS 601, the first AP 610, a first terminal 611, a second terminal 612, and a third terminal 621. Within a range of the second BSS 602, the second AP 620, a third terminal 621, a fourth terminal 622, and a fifth terminal 623 may be positioned. The first terminal 611 and the second terminal 612 may be associated with the first AP 610. The third terminal 621, the fourth terminal 622, and the fifth terminal 623 may be associated with the second AP 620. An AP controller 630 may be associated with the first AP 610 and the second AP 620 in a wired or wireless manner.

The centralized topology-based AP discovery method is AP discovery technology that uses the AP controller 630 applied to an enterprise network. First, each of the APs 610 and 620 may be associated with the AP controller 630, and transmit its own position information, coverage information, and the like to the AP controller 630. Thereafter, each of the APs 610 and 620 may transmit an AP discovery request frame to the AP controller 630. The AP controller 630 may transmit an AP discovery response frame including position information of an AP, coverage information, and the like, which are registered as a response to the AP discovery request frame, to each of the APs 610 and 620. Each of the APs 610 and 620 may acquire information about neighbor APs including a hidden AP based on the information included in the AP discovery response frame.

The centralized topology-based AP discovery method is useful in networks using the same service provider network or the same WLAN solution, but is difficult to be used between different service provider networks and in an environment in which a private AP exists.

Meanwhile, according to the distributed topology-based AP discovery method, an AP may discover neighbor APs even without the AP controller 630. The distributed topology-based AP discovery method may be classified into a passive method, an active method, and a station assistance method.

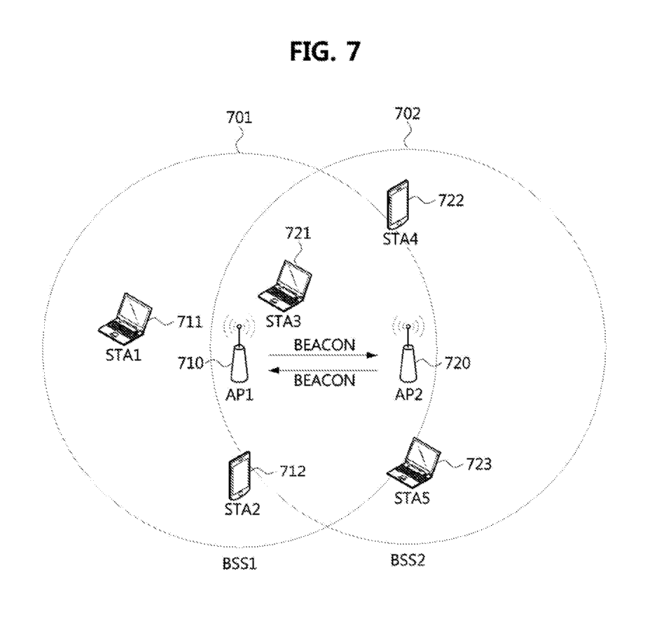

FIG. 7 is a conceptual diagram illustrating a passive method of a distributed topology-based AP discovery method.

Referring to FIG. 7, a first AP 710 may constitute a first BSS 701, and a second AP 720 may constitute a second BSS 702. Within a range of the first BSS 701, the first AP 710, the second AP 720, a first terminal 711, a second terminal 712, and a third terminal 721 may be positioned. Within a range of the second BSS 702, the first AP 710, the second AP 720, the third terminal 721, a fourth terminal 722, and a fifth terminal 723 may be positioned. The first terminal 711 and the second terminal 712 may be associated with the first AP 710. The third terminal 721, the fourth terminal 722, and the fifth terminal 723 may be associated with the second AP 720.

The first AP 710 may transmit a beacon frame in a broadcast method, and the second AP 720 may receive the beacon frame transmitted from the first AP 710. The second AP 720 may transmit a beacon frame in a broadcast method, and the first AP 710 may receive the beacon frame transmitted from the second AP 720. That is, each of the APs 710 and 720 may identify the existence of a neighbor AP based on the beacon frame received from the neighbor AP.

However, the passive method of the distributed topology-based AP discovery method may be used only when a corresponding AP is positioned in a region where the corresponding AP can receive the beacon frame transmitted from the other APs. Thus, when the AP is not positioned in the region where the AP can receive the beacon frame transmitted from the other APs, the passive method of the distributed topology-based AP discovery method may not be used.

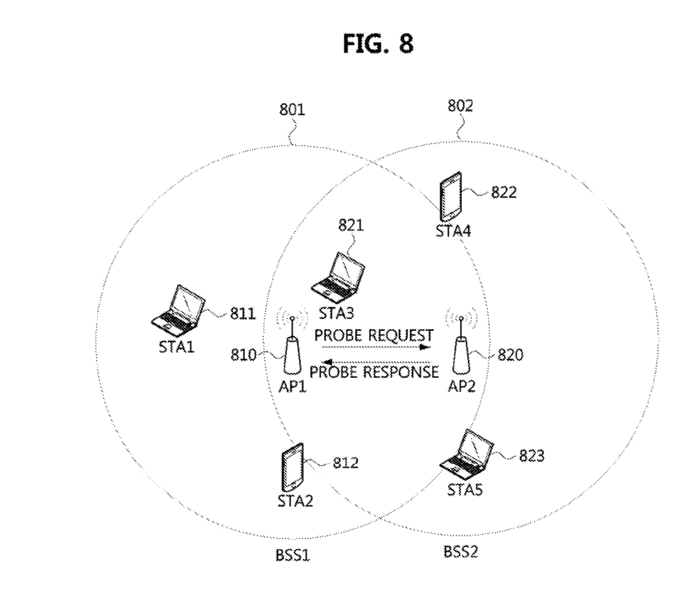

FIG. 8 is a conceptual diagram illustrating an active method of a distributed topology-based AP discovery method.

Referring to FIG. 8, a first AP 810 may constitute a first BSS 801, and a second AP 820 may constitute a second BSS 802. Within a range of the first BSS 801, the first AP 810, the second AP 820, a first terminal 811, a second terminal 812, and a third terminal 821 may be positioned. Within a range of the second BSS 802, the first AP 810, the second AP 820, the third terminal 821, a fourth terminal 822, and a fifth terminal 823 may be positioned. The first terminal 811 and the second terminal 812 may be associated with the first AP 810. The third terminal 821, the fourth terminal 822, and the fifth terminal 823 may be associated with the second AP 820.

The first AP 810 may transmit a probe request frame. When receiving the probe request frame from the first AP 810, the second AP 820 may transmit a probe response frame that is a response to the probe request frame to the first AP 810. When receiving the probe response frame that is the response to the probe request frame, the first AP 810 may identify the existence of the second AP 820.

However, the active method of the distributed topology-based AP discovery method may be used only when a corresponding AP is positioned in a region where the corresponding AP can receive the probe request frame (or probe response frame) from the other APs. Thus, when the AP is not positioned in the region where the AP can receive the probe request frame (or probe response frame) transmitted from the other APs, the active method of the distributed topology-based AP discovery method may not be used.

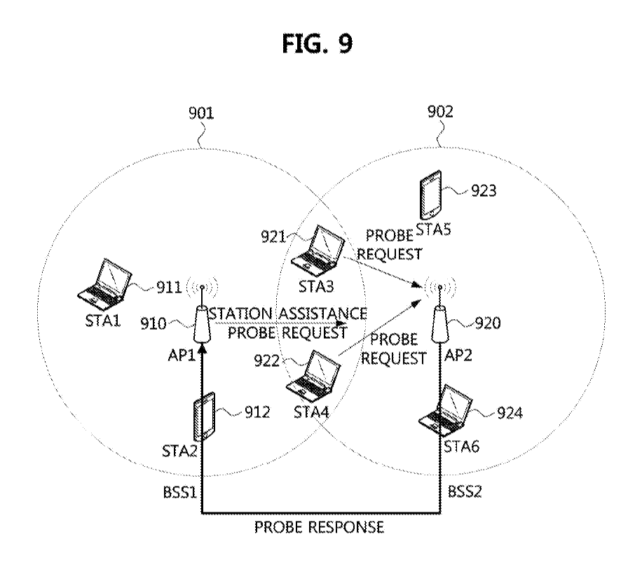

FIG. 9 is a conceptual diagram illustrating a station assistance method of a distributed topology-based AP discovery method.

Referring to FIG. 9, a first AP 910 may constitute a first BSS 901, and a second AP 920 may constitute a second BSS 902. Within a range of the first BSS 901, the first AP 910, a first terminal 911, a second terminal 912, a third terminal 921, and a fourth terminal 922 may be positioned. Within a range of the second BSS 902, the second AP 920, the third terminal 921, the fourth terminal 922, a fifth terminal 923, and a sixth terminal 924 may be positioned. The first terminal 911 and the second terminal 912 may be connected to the first AP 910. The third terminal 921, the fourth terminal 922, the fifth terminal 923, and the sixth terminal 924 may be connected to the second AP 920. Here, the third terminal 921 and the fourth terminal 922 may be positioned in a region where the first BSS 901 and the second BSS 902 are overlapped with each other. The first AP 910 and the second AP 920 may be in a hidden-AP relationship.

The station assistance method of the distributed topology-based AP discovery method is an AP discovery method that uses a terminal positioned in a region where BSSs are overlapped with one another. Specifically, the first AP 910 may periodically or non-periodically transmit a station assistance probe request frame so that the terminals 921 and 922 positioned in the region where the first BSS 901 and the second BSS 902 are overlapped with each other can receive the station assistance probe request frame. When receiving the station assistance probe request frame, each of the terminals 921 and 922 positioned in the overlapped region may transmit the probe request frame to the second AP 920 to which each of the terminals 921 and 922 is connected. Here, the probe request frame transmitted by each of the terminals 921 and 922 positioned in the overlapped region may include information about the first AP 910.

When receiving the probe request frame generated based on the station assistance probe request frame from the third terminal 921 or the fourth terminal 922, the second AP 920 may identify the existence of the first AP 910. Thereafter, the second AP 920 may transmit a probe response frame that is a response to the probe request frame to the first AP 910 in a wired manner. When receiving the probe response frame that is the response to the station assistance probe request frame, the first AP 910 may identify the existence of the second AP 920.

The distributed topology-based AP discovery method described above may be partially applied to WLAN based on a distributed system. The passive method and the active method of the distributed topology-based AP discovery method may be applied to IEEE 802.11 standard to be applicable between different service provider networks, in an environment in which a private AP exists, and the like, but have a limitation in discovering a hidden AP.

In order to discover the hidden AP, assistance of the terminal positioned in the region where the BSSs are overlapped with one another is needed. According to the station assistance method of the distributed topology-based AP discovery method, a corresponding AP should periodically or non-periodically transmit the station assistance probe request frame in order to use a terminal that is not connected to the corresponding AP, and overhead may occur due to transmission of the station assistance probe request frame. In addition, each of the terminals having received the station assistance probe request frame should transmit the probe request frame to an AP connected to each of the terminals having received the station assistance probe request frame, and overhead may occur due to transmission of the probe request frame according to the station assistance probe request frame. In addition, in a case in which communication among APs is possible in a wired manner, transmission and reception of the probe response frame is possible, and therefore a procedure for connection setup between the APs is necessarily needed, and therefore it is not easy to apply the station assistance method to a variety of WLAN devices.

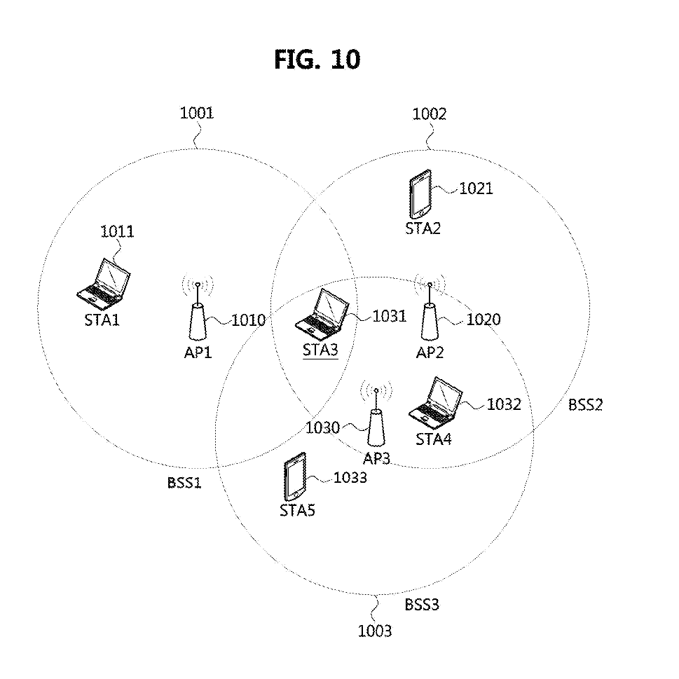

FIG. 10 is a conceptual diagram illustrating still another example of a network in which BSSs are overlapped with each other.

Referring to FIG. 10, a first AP 1010 may constitute a first BSS 1001, a second AP 1020 may constitute a second BSS 1002, and a third AP 1030 may constitute a third BSS 1003. Within a range of the first BSS 1001, the first AP 1010, a first terminal 1011, and a third terminal 1031 may be positioned. Within a range of the second BSS 1002, the second AP 1020, the third AP 1030, the second terminal 1021, the third terminal 1031, and a fourth terminal 1032. Within a range of the third BSS 1003, the second AP 1020, the third AP 1030, the third terminal 1031, the fourth terminal 1032, and the fifth terminal 1033 may be positioned.

The first terminal 1011 may be associated with the first AP 1010. The second terminal 1021 may be associated with the second AP 1020. The third terminal 1031, the fourth terminal 1032, and the fifth terminal 1033 may be associated with the third AP 1030. The third terminal 1031 may be positioned in a region in which the first BSS 1001, the second BSS 1002, and the third BSS 1003 are overlapped with one another. The second AP 1020, the third AP 1030, and the fourth terminal 1032 may be positioned in a region in which the second BSS 1002 and the third BSS 1003 are overlapped with each other.

Hereinafter, an AP discovery method in the network shown in FIG. 10 will be described.

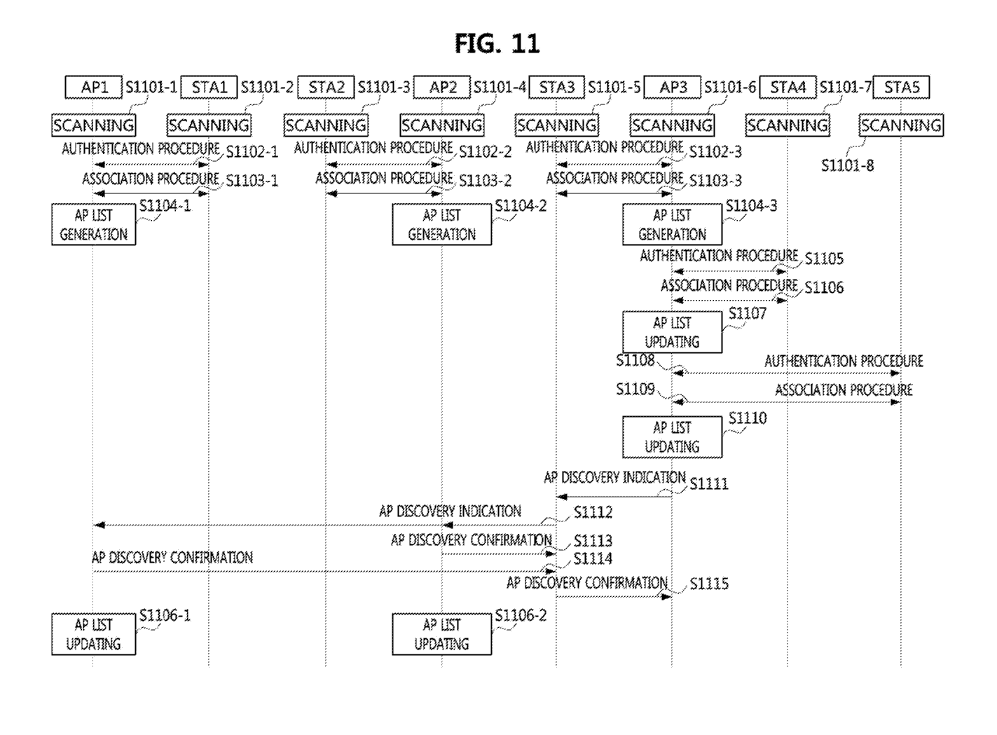

FIG. 11 is a flowchart illustrating an AP discovery method according to an embodiment of the present invention.

Referring to FIG. 11, a first AP AP1, a second AP AP2, a third AP AP3, a first terminal STA1, a second terminal STA2, a third terminal STA3, a fourth terminal STA4, and a fifth terminal STA5 may be the same as each communication object shown in FIG. 10.

Each of the communication objects AP1, AP2, AP3, STA1, STA2, STA3, STA4, and STA5 may perform scanning procedures S1101-1, S1101-2, S1101-3, S1101-4, S1101-5, S1101-6, S1101-7, and S1101-8. That is, each of the communication objects AP1, AP2, AP3, STA1, STA2, STA3, STA4, and STA5 may detect neighbor communication objects based on at least one of a passive scanning method and an active scanning method.

For example, the first AP AP1 may detect the first terminal STA1, the third terminal STA3, and the like through channel scanning procedures. The second AP AP2 may detect the third AP AP3, the second terminal STA2, the third terminal STA3, the fourth terminal STA4, and the like through the channel scanning procedures. The third AP AP3 may detect the second AP AP2, the third terminal STA3, the fourth terminal STA4, the fifth terminal STA5, and the like through the channel scanning procedures. The first terminal STA1 may detect the first AP AP1, and the like through the channel scanning procedures. The second terminal STA2 may detect the second AP AP2, and the like through the channel scanning procedures. The third terminal STA3 may detect the first AP AP1, the second AP AP2, the third AP AP3, and the like through the channel scanning procedures. The fifth terminal STA5 may detect the third AP AP3, and the like through the channel scanning procedures.

Next, AP list generation procedures between the first AP AP1 and the first terminal STA1, AP list generation procedures between the second AP AP2 and the second terminal STA2, and AP list generation procedures between the third AP AP3 and the third terminal STA3 will be described.

AP List Generation Procedures Between First AP AP1 and First Terminal STA1

The first terminal STA1 may perform an authentication procedure with the first AP AP1 among at least one AP detected through the channel scanning procedure in operation S1102-1. That is, the first terminal STA1 may transmit an authentication request frame to the first AP AP1, and the first AP AP1 may transmit, when receiving the authentication request frame, an authentication response frame that is a response to the authentication request frame to the first terminal STA1. Through this process, the authentication procedure between the first terminal STA1 and the first AP AP1 may be completed.

The first terminal STA1 may perform an association procedure with the first AP AP1 in which the authentication procedure has been performed in operation S1103-1. That is, the first terminal STA1 may transmit an association request frame to the first AP AP1, and the first AP AP1 may transmit, when receiving the association request frame, an association response frame that is a response to the association request frame to the first terminal STA1. Through this process, the association procedure between the first terminal STA1 and the first AP AP1 may be completed.

Meanwhile, the first terminal STA1 may transmit information detected by the channel scanning procedure to the first AP AP1. For example, the first terminal STA1 may transmit the information detected by the channel scanning procedure to the first AP AP1 through the association procedure. In this case, the first terminal STA1 may transmit an association request frame including the information detected by the channel scanning procedure to the first AP AP1. Alternatively, the first terminal STA1 may transmit the information detected by the channel scanning procedure to the first AP AP1 after completing the association procedure. In this case, the first terminal STA1 may receive an association response frame from the first AP AP1, and then transmit an arbitrary frame including the information detected by the channel scanning procedure to the first AP AP1.

Here, the information detected by the channel scanning procedure may mean information about a communication object positioned in a region where the communication object can communicate with the first terminal STA1. The information about the communication object may mean identification information of the communication object such as an MAC address, an association identifier (AID), a partial association identifier (PAID), and the like.

The first AP AP1 may acquire, from the first terminal STA1, the information detected by the channel scanning procedure having been performed in the first terminal STA1. For example, the first AP AP1 may acquire the information detected by the channel scanning procedure having been performed in the first terminal STA1 from the association request frame transmitted from the first terminal STA1. Alternatively, the first AP AP1 may acquire the information detected by the channel scanning procedure having been performed in the first terminal STA1 from an arbitrary frame transmitted from the first terminal STA1 after the association procedure.

The first AP AP1 may generate an AP list based on the information detected by the channel scanning procedure having been performed in the first AP AP1 and the information detected by the channel scanning procedure having been performed in the first terminal STA1 in operation S1104-1.

Specifically, the first AP AP1 may generate an AP list including at least one AP indicated by the information detected by the channel scanning procedure having been performed in the first AP AP1 and at least one AP indicated by the information detected by the channel scanning procedure having been performed in the first terminal STA1.

In particular, the first AP AP1 may determine, to be a hidden AP, an AP which does not exist in the information detected by the channel scanning procedure having been performed in the first AP AP1, but exists in the information detected by the channel scanning procedure having been performed in the first terminal STA1.

AP List Generation Procedure Between Second AP AP2 and Second Terminal STA2

The AP list generation procedure between the second AP AP2 and the second terminal STA2 may be the same as the AP list generation procedure between the first AP AP1 and the first terminal STA1.

Specifically, the second terminal STA2 may perform an authentication procedure (that is, exchange between the authentication request frame and the authentication response frame) with the second AP AP2 among at least one AP detected through the channel scanning procedure in operation S1102-2. The second terminal STA2 may perform an association procedure (that is, exchange between the association request frame and the association response frame) with the second AP AP2 in which the authentication procedure has been performed in operation S1103-2. The second terminal STA2 may transmit the information detected by the channel scanning procedure to the second AP AP2 through the association procedure or a separate procedure after the association procedure. When acquiring the information detected by the channel scanning procedure having been performed in the second terminal STA2, the second AP AP2 may generate an AP list based on the information detected by the channel scanning procedure having been performed in the second AP AP2 and the information detected by the channel scanning procedure having been performed in the second terminal STA2 in operation S1104-2.

AP List Generation Procedure Between Third AP AP3 and Third Terminal STA3

The AP list generation procedure between the third AP AP3 and the third terminal STA3 may be the same as the AP list generation procedure between the first AP AP1 and the first terminal STA1 described above.

Specifically, the third terminal STA3 may perform an authentication procedure (that is, exchange between the authentication request frame and the authentication response frame) with the third AP AP3 among at least one AP detected through the channel scanning procedure in operation S1102-3. The third terminal STA3 may perform an association procedure (that is, exchange between the authentication request frame and the association response frame) with the third AP AP3 in which the authentication procedure has been performed in operation S1103-3. The third terminal STA3 may transmit the information detected by the channel scanning procedure to the third AP AP3 through the association procedure or a separate procedure after the association procedure. When acquiring, from the third terminal STA3, the information detected by the channel scanning procedure having been performed in the third terminal STA3, the third AP AP3 may generate the AP list based on the information detected by the channel scanning procedure having been performed in the third AP AP3 and the information detected by the channel scanning procedure having been performed in the third terminal STA3 in operation S1104-3.

Here, when identification information of the first AP AP1 does not exist in the information detected by the channel scanning procedure having been performed in the third AP AP3, but exists in the information detected by the channel scanning procedure having been performed in the third terminal STA3, the third AP AP3 may determine the first AP AP1 to be a hidden AP.

Next, an AP list updating procedure will be described. The AP list may be updated when a corresponding AP is associated with a new terminal and when the corresponding AP receives information (or AP list generated by other communication objects) detected by the channel scanning procedure having been performed in the other communication objects (that is, AP).

AP List Updating Procedure by Association with New Terminal

The third AP AP3 may perform an authentication procedure (that is, exchange between the authentication request frame and the authentication response frame) with a new fourth terminal STA4 in operation S1105 after generating the AP list. Next, the third AP AP3 may perform an association procedure (that is, exchange between the association request frame and the association response frame) with the fourth terminal STA4 in which the authentication procedure has been performed in operation S1106. The fourth terminal STA4 may transit the information detected by the channel scanning procedure to the fourth AP AP4 through the association procedure or a separate procedure after the association procedure.

Here, the authentication procedure between the third AP AP3 and the fourth terminal STA4 may be the same as the authentication procedure between the first AP AP1 and the first terminal STA1 described above. The transmission and reception procedure of the information detected by the channel scanning procedure between the third AP AP3 and the fourth terminal STA4 may be the same as the transmission and reception procedure of the information detected by the channel scanning procedure between the first AP AP1 and the first terminal STA1.

The third AP AP3 may update the AP list based on the information detected by the channel scanning procedure having been performed in the fourth terminal STA4 acquired from the fourth terminal STA4 in operation S1107.

Specifically, the third AP AP3 may update the AP list so as to include at least one AP indicated by the detected by the channel scanning procedure having been performed in the fourth terminal STA4. In particular, the third AP AP3 may determine, to be a hidden AP, an AP which does not exist in the information detected by the channel scanning procedure having been performed in the third AP AP3, but exists in the information detected by the channel scanning procedure having been performed in the fourth terminal STA4.

Meanwhile, the third AP AP3 may perform an authentication procedure (that is, exchange between the authentication request frame and the authentication response frame) with a new fifth terminal STA5 in operation S1108 after updating the AP list. Next, the third AP AP3 may perform an association procedure (that is, exchange between the association request frame and the association response frame) with the fifth terminal STA5 in which the authentication procedure has been performed in operation S1109. The fifth terminal STA5 may transmit the information detected by the channel scanning procedure to the third AP AP3 through the association procedure or a separate procedure after the association procedure.

Here, the authentication procedure between the third AP AP3 and the fifth terminal STA5 may be the same as the authentication procedure between the first AP AP1 and the first terminal STA1 described above. The association procedure between the third AP AP3 and the fifth terminal STA5 may be the same as the association procedure between the first AP AP1 and the first terminal STA1. The transmission and reception procedure of the information detected by the channel scanning procedure between the third AP AP3 and the fifth terminal STA5 may be the same as the transmission and reception procedure of the information detected by the channel scanning procedure between the first AP AP1 and the first terminal STA1 described above.

The third AP AP3 may update the AP list based on the information detected by the channel scanning procedure having been performed in the fifth terminal STA5 acquired from the fifth terminal STA5 in operation S1110.

Specifically, the third AP AP3 may update the AP list so as to include at least one AP indicated by the information detected by the channel scanning procedure having been performed in the fifth terminal STA5. In particular, the third AP AP3 may determine, to be a hidden AP, an AP which does not exist in the information detected by the channel scanning procedure having been performed in the third AP AP3, but exists in the information detected by the channel scanning procedure having been performed in the fifth terminal STA5.

AP List Updating Procedure Based on Information Detected by Channel Scanning Procedure of Other Communication Objects (or AP List Generated by Other Communication Objects)

The third AP AP3 may transmit an AP discovery indication frame including at least one of the information detected by the channel scanning procedure having been performed in the third AP AP3 and the AP list generated by the third AP AP3 in operation S1111. The third AP AP3 may transmit the AP discovery indication frame in a broadcast method, a multicast method, or a unicast method.

When transmitting the AP discovery indication frame in the unicast method, the third AP AP3 may transmit the AP discovery indication frame to the terminal that detects the largest number of APs through the channel scanning procedure among the terminals STA3, STA4, and STA5 connected to the third AP AP3.

Here, the third terminal STA3 has detected three APs AP1, AP2, and AP3 through the channel scanning procedure, the fourth terminal STA4 has detected two APs AP2 and AP3 through the channel scanning procedure, and the fifth terminal STA5 has detected one AP AP3 through the channel scanning procedure. Thus, the third AP AP3 may transmit the AP discovery indication frame to the third terminal STA3.

The third terminal STA3 may receive the AP discovery indication frame from the third AP AP3, and transmit the received AP discovery indication frame in operation S1112. In this case, the third terminal STA3 may transmit the AP discovery indication frame in the broadcast method, the multicast method, or the unicast method.

Meanwhile, the first AP AP1 and the second AP AP2 may receive the AP discovery indication frame transmitted from the third terminal STA3. That is, the third terminal STA3 means arbitrary terminal which is not associated to first AP AP1 or the second AP AP2. When successfully receiving the AP discovery indication frame, the second AP AP2 may transmit, to the third terminal STA3, an AP discovery confirmation frame that is a response to the AP discovery indication frame in operation S1113. The AP discovery confirmation frame transmitted by the second AP AP2 may include at least one of information for connection setup with the second AP AP2 and operating channel information of the second AP AP2. Alternatively, when successfully receiving the AP discovery indication frame, the second AP AP2 may transmit, to the third terminal STA3, a beacon frame (which is used instead of the AP discovery confirmation frame) that is a response to the AP discovery indication frame. The beacon frame may include at least one of information for connection setup with the second AP AP2 and operating channel information of the second AP AP2.

When successfully receiving the AP discovery indication frame, the first AP AP1 may transmit the AP discovery confirmation frame that is the response to the AP discovery indication frame in operation S1114. The AP discovery confirmation frame transmitted by the first AP AP1 may include information for connection setup with the first AP AP1 and the operating channel information of the first AP AP1. Alternatively, when successfully receiving the AP discovery indication frame, the first AP AP1 may transmit, to the third terminal STA3, a beacon frame (which is used instead of the AP discovery confirmation frame) that is a response to the AP discovery indication frame. The beacon frame may include at least one of information for connection setup with the first AP AP1 and operating channel information of the first AP AP1.

The third terminal STA3 may transmit, to the third AP AP3, the AP discovery confirmation frame received from the first AP AP1 and the second AP AP2 in operation S1115. When receiving the beacon frame in response to the AP discovery indication frame from the first AP AP1 and the second AP AP2, the third terminal STA3 may transmit the AP discovery confirmation frame which indicates that the AP discovery indication frame has been successfully received at each of APs (AP1, AP2) to the third AP AP3.

The first AP AP1 may update the AP list based on information included in the AP discovery indication frame in operation S1116-1. Specifically, the first AP AP1 may acquire, from the AP discovery indication frame, the information detected by the channel scanning procedure having been performed in the third AP AP3. The first AP AP1 may update the AP list so as to include at least one AP indicated by the information detected by the channel scanning procedure having been performed in the third AP AP3. In particular, the first AP AP1 may determine, to be a hidden AP, an AP which does not exist in the information detected by the channel scanning procedure having been performed in the first AP AP1, but exists in the information detected by the channel scanning procedure having been performed in the third AP AP3.

Alternatively, the first AP AP1 may acquire the AP list generated by the third AP AP3 from the AP discovery indication frame. The first AP AP1 may update the AP list so as to include at least one AP which exists in the AP list generated by the third AP AP3. In particular, the first AP AP1 may determine, to be a hidden AP, an AP which does not exist in the information detected by the channel scanning procedure having been performed in the first AP AP1, but exists in the AP list among the AP lists generated by the third AP AP3. For example, the first AP AP1 may determine, to be hidden APs, the second AP AP2 and the third AP AP3 based on the AP discovery indication frame.

The second AP AP2 may update the AP list based on the information included in the AP discovery indication frame in operation S1116-2. The procedure of updating the AP list in the second AP AP2 may be the same as the procedure of updating the AP list in the first AP AP1 described above.

Here, a case in which the AP list updating operations S1116-1 and S1116-2 are respectively performed after the operations S1114 and S1113 of transmitting the AP discovery confirmation frame has been described, but the AP list updating operations S1116-1 and S1116-2 may be respectively performed before or simultaneously the operations S1114 and S1113 of transmitting the AP discovery confirmation frame.

As described above, according to the present invention, the interference problem between the neighbor APs may be solved.

The embodiments of the present invention may be implemented in the form of program instruction that can be executed through various computer means and recorded in a computer-readable medium. The computer-readable medium may separately include program instructions, data files, data structures, etc. or include a combination of them. The program command recorded in the computer-readable medium may be specially designed and configured for the present invention, or known and available to those of ordinary skill in the field of computer software. The computer-readable medium may mean a hardware device particularly configured to store and perform the program instructions such as a ROM, RAM, flash memory, or the like. The hardware device may be configured to be operated as at least one software module so as to perform the operations according to the embodiments of the present invention, and vice versa.

Examples of the computer-readable recording medium include magnetic media, such as a hard disk, a floppy disk, and a magnetic tape, optical media, such as a CD-ROM and a DVD, magneto-optical media, such as a floptical disk, and hardware devices, such as a ROM, a RAM, and a flash memory, specially configured to store and perform program commands. Examples of the program instructions may include high-level language codes executable by a computer using an interpreter, etc. as well as machine language codes made by compilers. An example of the program instruction may include a machine language code such as ones made by a complier and an advanced language code that may be executed by a computer using an interpreter, or the like.

While the example embodiments of the present invention and their advantages have been described in detail, it should be understood that various changes, substitutions and alterations may be made herein without departing from the scope of the invention.

What is claimed is:

1. A discovery method which is performed in a first access point (AP), comprising:
performing a scanning procedure;
performing an authentication procedure with a first terminal detected through the scanning procedure;
performing an association procedure with the first terminal in which the authentication procedure has been performed;
acquiring, from the first terminal, a scanning result of a scanning procedure having been performed in the first terminal; and
generating a first AP list based on a scanning result of a scanning procedure having been performed in the first AP and the scanning result of the scanning procedure having been performed in the first terminal.

2. The discovery method of claim 1, wherein the scanning result includes information about at least one AP detected through the scanning procedure.

3. The discovery method of claim 1, wherein the first AP list includes at least one AP detected through the scanning procedure having been performed in the first AP and at least one AP detected through the scanning procedure having been performed in the first terminal.

4. The discovery method of claim 1, further comprising:
transmitting a first AP discovery indication frame including at least one of the scanning result of the scanning procedure having been performed in the first AP and the first AP list to a terminal satisfying a preset criterion among at least one terminal associated with the first AP; and
receiving a first AP discovery confirmation frame that is a response to the first AP discovery indication frame from the terminal satisfying the preset criterion.

5. The discovery method of claim 4, wherein the terminal satisfying the preset criterion is a terminal that detects the largest number of APs through the scanning procedure among the at least one terminal associated with the first AP.

6. The discovery method of claim 1, further comprising:
receiving a second AP discovery indication frame from a second terminal;
transmitting a second AP discovery confirmation frame to the second terminal as a response to the second AP discovery indication frame; and
updating the first AP list based on information included in the second AP discovery indication frame,
wherein the second AP discovery indication frame includes at least one of a scanning result of a scanning procedure having been performed in the AP that generates the second AP discovery indication frame and a second AP list generated in the AP that generates the second AP discovery indication frame.

7. The discovery method of claim 6, wherein the second AP discovery confirmation frame includes at least one of information for connection setup with the first AP and operating channel information of the first AP.

8. The discovery method of claim 1, further comprising:
performing an authentication procedure with a third terminal;
performing an association procedure with the third terminal in which the authentication procedure has been performed;
acquiring, from the third terminal, a scanning result of a scanning procedure having been performed in the third terminal; and
updating the first AP list based on the scanning result of the scanning procedure having been performed in the third terminal.

9. A discovery method which is performed in a first terminal, comprising:
performing a scanning procedure;
performing an authentication procedure with a first AP detected through the scanning procedure;
performing an association procedure with the first AP in which the authentication procedure has been performed; and
transmitting a scanning result of a scanning procedure having been performed in the first terminal to the first AP.

10. The discovery method of claim 9, wherein the scanning result includes information about at least one AP detected through the scanning procedure.

11. The discovery method of claim 9, further comprising:
receiving, from the first AP, a first AP discovery indication frame including at least one of a first AP list generated based on the scanning result of the scanning procedure having been performed in the first terminal and a scanning result of a scanning procedure having been performed in the first AP, and the scanning result of the scanning procedure having been performed in the first AP;
transmitting the first AP discovery indication frame;
receiving, from at least one AP that receives the first AP discovery indication frame, a first AP discovery confirmation frame that is a response to the first AP discovery indication frame; and
transmitting the first AP discovery confirmation frame to the first AP.

12. The discovery method of claim 11, wherein the first AP list includes at least one AP detected through the scanning procedure having been performed in the first AP and at least one AP detected through the scanning procedure having been performed in the first terminal.

13. The discovery method of claim 11, wherein the first AP discovery confirmation frame includes at least one of information for connection setup with the AP that transmits the first AP discovery confirmation frame and operating channel information of the AP that transmits the first AP discovery confirmation frame.

14. The discovery method of claim 11, wherein a beacon frame instead of the first AP discovery confirmation frame is used to a response of the first AP discovery indication frame.

15. A first AP comprising:
a processor; and
a memory in which at least one program command executed through the processor is stored,
wherein the at least one program command is executable to perform steps of:
performing a scanning procedure;
performing an authentication procedure with a first terminal detected through the scanning procedure;
performing an association procedure with the first terminal in which the authentication procedure has been performed;
acquiring, from the first terminal, a scanning result of a scanning procedure having been performed in the first terminal; and
generating a first AP based on a scanning result of a scanning procedure having been performed in the first AP and the scanning result of the scanning procedure having been performed in the first terminal.

16. The first AP of claim 15, wherein the first AP list includes at least one AP detected through the scanning procedure having been performed in the first AP and at least one AP detected through the scanning procedure having been performed in the first terminal.

17. The first AP of claim 15, wherein the at least one program command is executable to further perform steps of:
transmitting a first AP discovery indication frame including at least one of the scanning result of the scanning procedure having been performed in the first AP and the first AP list to a terminal satisfying a preset criterion among at least one terminal associated with the first AP; and
receiving a first AP discovery confirmation frame as a response to the first AP discovery indication frame from the terminal satisfying the preset criterion.

18. The first AP of claim 17, wherein the terminal satisfying the preset criterion is a terminal that detects the largest number of APs through the scanning procedure among the at least one terminal associated with the first AP.

19. The first AP of claim 15, wherein the at least one program command is executable to further perform steps of:
receiving a second AP discovery indication frame from a second terminal;
transmitting, to the second terminal, a second AP discovery confirmation frame that is a response to the second AP discovery indication frame; and
updating the first AP list based on information included in the second AP discovery indication frame, and
the second AP discovery indication frame includes at least one of a scanning result of a scanning procedure having been performed in the AP that generates the second AP discovery indication frame and a second AP list generated in the AP that generates the second AP discovery indication frame.

20. The first AP of claim 15, wherein the at least one program command is executable to further perform steps of:
performing an authentication procedure with a third terminal;
performing an association procedure with the third terminal in which the authentication procedure has been performed;
acquiring, from the third terminal, a scanning result of a scanning procedure having been performed in the third terminal; and
updating the first AP list based on the scanning result of the scanning procedure having been performed in the third terminal.
